(19) United States
(12) Patent Application Publication
(10) Pub. No.: US 2025/0371877 A1
(43) Pub. Date: Dec. 4, 2025

(54) VIDEO PROCESSING METHOD, AND ELECTRONIC DEVICE

(71) Applicants: Lemon Inc., Grand Cayman (KY); Beijing Zitiao Network Technology Co., Ltd., Haidian District, Beijing (CN)

(72) Inventors: Xiaojie JIN, Los Angeles, CA (US); Yaojie SHEN, Beijing (CN); Kai XU, Beijing (CN)

(21) Appl. No.: 18/876,318

(22) PCT Filed: Jun. 27, 2023
(86) PCT No.: PCT/CN2023/102818

§ 371 Date: Dec. 18, 2024

(30) Foreign Application Priority Data
Jul. 8, 2022 (CN) 202210806771.4

(51) Int. Cl. G06V 20/40; G06T 13/00; G06V 10/74; G06V 10/764; G06V 10/80; G06V 10/82

(52) U.S. Cl. CPC G06V 20/49; G06T 13/00; G06V 10/761; G06V 10/764; G06V 10/806; G06V 20/46; G06V 10/82

(57) ABSTRACT

The present disclosure provides a video processing method and apparatus, and an electronic device, and the method includes: acquiring a first video, in which the first video includes a plurality of material videos; determining a fusion video feature corresponding to adjacent material videos, in which the fusion video feature is used to indicate image features and audio features of adjacent material videos; acquiring a plurality of transition effect features corresponding to a plurality of video transition effects; determining a target video transition effect between the adjacent material videos from the plurality of video transition effects according to the fusion video feature and the plurality of transition effect features; and determining a second video according to the plurality of material videos and the target video transition effect.

### CROSS-REFERENCE TO RELATED APPLICATION

The present application claims the priority to Chinese patent application No. 202210806771.4, filed on Jul. 8, 2022, entitled “VIDEO PROCESSING METHOD AND APPARATUS, AND ELECTRONIC DEVICE,” the entire disclosure of which is incorporated herein by reference as portion of the present application.

### TECHNICAL FIELD

Embodiments of the present disclosure relate to the field of computer vision and artificial intelligence technology, and in particular to an interactive segmentation model training method, and a labeling data generation method and device.

### BACKGROUND

In video clipping, an electronic device is capable of merging a plurality of captured material videos into one video, and therefore, transition effects need to be inserted between the plurality of material videos to improve the effect of the video.

At present, transition effects may be added between the plurality of material videos by a transition effect template on the electronic device. For example, the transition effect template includes a plurality of preset transition effects. The electronic device may sequentially insert the preset transition effects between the material videos according to an arrangement order of the material videos, thereby obtaining a video by merging the material videos. However, the material videos greatly differ in content, and in response to the preset transition effects being sequentially added between the material videos, the matching degrees of the transition effects with adjacent material videos are low, thereby resulting in a poor video synthesis effect.

### SUMMARY

The present disclosure provides a video processing method and apparatus, and an electronic device, to solve the technical problem of poor video synthesis effect.

In a first aspect, the present disclosure provides a video processing method, which includes:
acquiring a first video, in which the first video includes a plurality of material videos;
determining a fusion video feature corresponding to every adjacent material videos, in which the fusion video feature is used to indicate image features and audio features of adjacent material videos;
acquiring a plurality of transition effect features corresponding to a plurality of video transition effects;
determining a target video transition effect between the every adjacent material videos from the plurality of video transition effects according to the fusion video feature and the plurality of transition effect features; and
determining a second video according to the plurality of material videos and the target video transition effect.

In a second aspect, the present disclosure provides a video processing apparatus, which includes a first acquisition module, a first determination module, a second acquisition module, a second determination module, and a third determination module;
the first acquisition module is configured to acquire a first video, and the first video includes a plurality of material videos;
the first determination module is configured to determine a fusion video feature corresponding to every adjacent material videos, and the fusion video feature is used to indicate image features and audio features of adjacent material videos;
the second acquisition module is configured to acquire a plurality of transition effect features corresponding to a plurality of video transition effects;
the second determination module is configured to determine a target video transition effect between the every adjacent material videos from the plurality of video transition effects according to the fusion video feature and the plurality of transition effect features; and
the third determination module is configured to determine a second video according to the plurality of material videos and the target video transition effect.

In a third aspect, the present disclosure provides an electronic device, which includes a processor and a memory;
the memory is configured to store computer-executable instructions; and
the processor is configured to execute the computer-executable instructions stored in the memory, to perform the video processing method according to the first aspect or any embodiment in the first aspect.

In a fourth aspect, the present disclosure provides a computer-readable storage medium, which stores computer-executable instructions, and a processor, when executing the computer-executable instructions, implements the video processing method according to the first aspect or any embodiment in the first aspect.

In a fifth aspect, the present disclosure provides a computer program product, which includes a computer program, and the computer program, when executed by a processor, implements the video processing method according to the first aspect or any embodiment in the first aspect.

In a sixth aspect, the present disclosure provides a computer program, and when the computer program is executed by a processor, the video processing method according to the first aspect or any embodiment in the first aspect is implemented.

### BRIEF DESCRIPTION OF DRAWINGS

In order to more clearly illustrate the technical solutions of the embodiments of the present disclosure, the drawings that need to be used in description of the embodiments will be briefly described in the following. Apparently, the drawings in the following description are only some embodiments of the present disclosure. For those skilled in the art, other drawings can also be obtained based on these drawings without any inventive work.

FIG. 1 is a schematic diagram of an application scenario provided by the embodiments of the present disclosure;

FIG. 2 is a schematic flowchart of a video processing method provided by the embodiments of the present disclosure;

FIG. 3 is a schematic diagram of material videos provided by the embodiments of the present disclosure;

FIG. 4 is a schematic diagram of a first video segment and a second video segment provided by the embodiments of the present disclosure;

FIG. 5 is a schematic diagram of a video transition effect provided by the embodiments of the present disclosure;

FIG. 6 is a schematic diagram of a transition effect feature provided by the embodiments of the present disclosure;

FIG. 7 is a schematic diagram of determining a target video transition effect provided by the embodiments of the present disclosure;

FIG. 8 is a schematic flowchart of a method for determining a fusion video feature provided by the embodiments of the present disclosure;

FIG. 9 is a schematic diagram of a process of a video processing method provided by the embodiments of the present disclosure;

FIG. 10 is a schematic structural diagram of a video processing apparatus provided by the embodiments of the present disclosure; and

FIG. 11 is a schematic structural diagram of an electronic device provided by the embodiments of the present disclosure.

### DETAILED DESCRIPTION

Exemplary embodiments will be described in detail here, and the exemplary embodiments are shown in the drawings. In the case where the following description refers to the drawings, same numbers in different drawings represent the same or similar elements unless otherwise indicated. The implementations described in the following exemplary embodiments do not represent all implementations consistent with the present disclosure. Rather, they are merely examples of apparatuses and methods consistent with some aspects of the present disclosure, as detailed in the appended claims.

For ease of understanding, concepts involved in the embodiments of the present disclosure are explained below.

An electronic device is a device having wireless receiving and sending functions. The electronic device may be deployed on land, e.g., in a room or outdoors, held in hand, worn, or on a vehicle, or may be deployed on water (e.g., on a ship). The electronic device may be a mobile phone, a Pad, a computer with wireless receiving and sending functions, a virtual reality (VR) electronic device, an augmented reality (AR) electronic device, a wireless terminal in industrial control, an vehicle-mounted electronic device, a wireless terminal in self driving, a wireless electronic device in remote medical, a wireless electronic device in smart grid, a wireless electronic device in transportation safety, a wireless electronic device in smart city, a wireless electronic device in smart home, a wearable electronic device, or the like. The electronic device involved in the embodiments of the present disclosure may also be referred to as a terminal, user equipment (UE), an access electronic device, a vehicle-mounted terminal, an industrial control terminal, a UE unit, a UE station, a mobile station, a mobile platform, a distant station, a remote electronic device, a mobile device, a UE electronic device, a wireless communication device, a UE agent, a UE apparatus, or the like. The electronic device may be stationary or mobile.

In the related art, the electronic device is capable of merging a plurality of captured material videos into one video. Because the material videos differ in content, in order to improve the display effect of the video, it is necessary to add transition effects between the material videos so that the material videos can be displayed smoothly in a playing process. At present, transition effects may be added between the plurality of material videos by a transition effect template on the electronic device. For example, the transition effect template includes a plurality of transition effects provided sequentially, and the electronic device can sequentially add corresponding transition effects between the material videos by the transition effect template. However, the material videos greatly differ in content and the transition effects between different contents are also different, and in response to the preset transition effects being sequentially added between the material videos, the matching degrees of the transition effects with adjacent material videos are low, thereby resulting in a poor video synthesis effect.

In order to solve the above-mentioned technical problem, the embodiments of the present disclosure provide a video processing method, which includes: acquiring a first video including a plurality of material videos; determining an image feature and an audio feature corresponding to each of adjacent material videos to obtain a plurality of image features and a plurality of audio features, and determining a fusion video feature corresponding to the adjacent material videos according to the plurality of image features and the plurality of audio features; obtaining transition effect features of a plurality of video transition effects in advance by a model training approach, and then determining a similarity between a fusion feature of the adjacent material videos and each transition effect feature; then determining a video transition effect between the adjacent material videos according to the similarity, and setting the corresponding video transition effect between the adjacent material videos to determine a second video. In this way, due to the fusion video feature of the adjacent material videos in combination with the image features, the audio features, and context information, the fusion video feature can accurately indicate the video features of the adjacent material videos, and the video transition effect having the highest matching degree with the adjacent material video contents can be accurately determined with the fusion video feature and the maintained transition effect feature. Thus, the video synthesis effect can be improved.

Application scenarios of the embodiments of the present disclosure are described below with reference to the drawings.

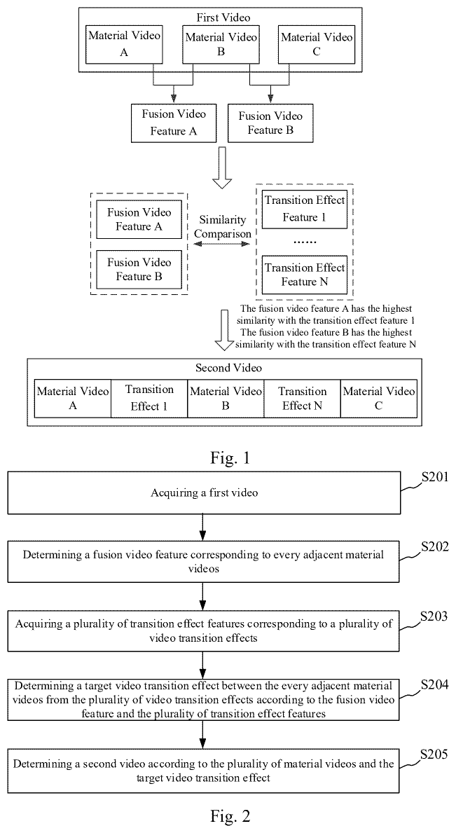

FIG. 1 is a schematic diagram of an application scenario provided by the embodiments of the present disclosure. Referring to FIG. 1, a first video is included. The first video includes material video A, material video B, and material video C. The material video A is earlier than the material video B, and the material video B is earlier than the material video C. Fusion video feature A is obtained according to the material video A and the material video B, and fusion video feature B is obtained according to the material video B and the material video C.

Referring to FIG. 1, N transition effect features are acquired, in which each transition effect feature corresponds to a unique video transition effect. A similarity between the fusion video feature A and each transition effect feature is acquired, and a similarity between the fusion video feature B and each transition effect feature is acquired. Because the fusion video feature A has the highest similarity with transition effect feature 1 and the fusion video feature B has the highest similarity with transition effect feature N, transition effect 1 corresponding to the transition effect feature 1 is acquired, and transition effect N corresponding to the transition effect feature N is acquired.

Referring to FIG. 1, the transition effect 1 is added between the material video A and the material video B, and the transition effect N is added between the material video B and the material C, whereby a second video is determined. In this way, the electronic device can automatically add the transition effects between the material videos of the first video, and because the fusion video feature is obtained by fusing the image features and the audio features of the adjacent material videos, the video transition effect having the highest matching degree with the adjacent material video contents can be accurately determined with the fusion video feature and the maintained transition effect features. Thus, the video synthesis effect can be improved.

Detail descriptions on the technical solutions of the present disclosure and how to solve the above-mentioned technical problem will be described below with specific embodiments. The following specific embodiments may be combined with each other, and the same or similar concepts or processes may not be repeatedly described in some embodiments. The embodiments of the present disclosure will be described in detail below with reference to the drawings.

FIG. 2 is a schematic flowchart of a video processing method provided by the embodiments of the present disclosure. Referring to FIG. 2, the video processing method may include the following steps.

S201: acquiring a first video.

The execution subject of the embodiments of the present disclosure may be an electronic device, or a video processing apparatus provided in the electronic device. The video processing apparatus may be implemented by software, or may be implemented by a combination of software and hardware.

Optionally, the first video includes a plurality of material videos. Optionally, the material videos may be a plurality of segments of video captured by the electronic device. For example, the material videos may be a plurality of segments of video captured by the electronic device that are different in video content. For example, the material videos may include a sky video, a sea video, a person video, and the like. After the electronic device captures a plurality of segments of material videos, the plurality of segments of material videos may be spliced to obtain the first video.

Optionally, the electronic device may acquire the first video from a database. For example, the electronic device receives a video processing request, in which the video processing request includes an identifier of the first video, and the electronic device acquires the first video from a plurality of videos stored in the database according to the identifier of the first video.

Optionally, the electronic device may also receive the first video sent by other devices. For example, the electronic device may receive a video sent by a server and determines the video as the first video, and the electronic device may also receive a video sent by other electronic devices and determine the video as the first video.

Optionally, the electronic device, after receiving the first video, may acquire a plurality of material videos in the first video. For example, the electronic device may divide the first video into a plurality of segments of video according to optical flow information of the first video, and each segment of video is a corresponding material video of the first video. The electronic device may also acquire the material videos of the first video in other ways such as model training, which will not be limited in the embodiments of the present disclosure.

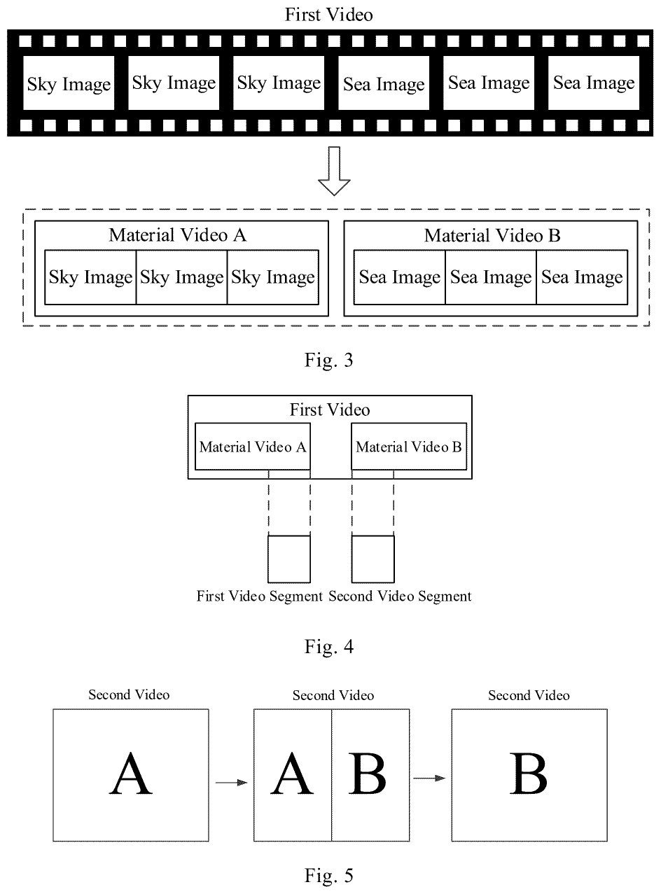

The material videos of the first video are described below with reference to FIG. 3.

FIG. 3 is a schematic diagram of material videos provided by the embodiments of the present disclosure. Referring to FIG. 3, a first video is included. The first video includes 3 frames of sky images and 3 frames of sea images. The first video is divided into two material videos according to the optical flow information of each image in the first video. Material video A includes 3 frames of sky images, and material video B includes 3 frames of sea images. In this way, images having similar contents are classified as the same material video according to the optical flow information, whereby the accuracy of the material video is improved.

S202: determining a fusion video feature corresponding to every adjacent material videos.

Optionally, the fusion video feature is used to indicate image features and audio features of adjacent material videos. For example, the fusion video feature may be a feature obtained by fusing the image features and the audio features of the adjacent material videos.

Optionally, the adjacent material videos may be determined according to the first video. For example, in response to the material videos of the first video being played in the following order: material video A, then material video B, and then material video C, the material video A and the material video B are adjacent material videos, and the material video B and the material video C are adjacent material videos.

Optionally, the fusion video feature corresponding to every adjacent material videos may be determined according to the following feasible implementation: determining image features and audio features corresponding to every adjacent material videos to obtain a plurality of image features and a plurality of audio features; and determining the fusion video feature corresponding to every adjacent material videos according to the plurality of image features and the plurality of audio features. For example, if the first video includes the material video A, the material video B, and the material video C, 2 image features and 2 audio features may be determined according to the adjacent material video A and material video B, and 2 image features and 2 audio features may be determined according to the adjacent material video B and material video C. Therefore, the electronic device can determine the fusion video feature between the adjacent material video A and material video B and the fusion video feature between the adjacent material video B and material video C according to 4 image features and 4 audio features.

Optionally, for any adjacent first material video and second material video, the electronic device may obtain a plurality of image features and a plurality of audio features according to the following feasible implementation: acquiring a first video segment in the first material video and a second video segment in the second material video; and determining the image features and the audio features corresponding to the first material video and the second material video according to the first video segment and the second video segment. For example, the first material video and the second material video may be any adjacent material videos of the plurality of material videos of the first video; the first video segment is a segment of video of the first material video, and the second video segment is a segment of video of the second material video; and the audio features and the video features may be determined with the two segments of video.

Optionally, the first material video is earlier than the second material video. For example, in the first video, the first material video is adjacent to the second material video, and the first material video is played prior to the second material video.

Optionally, in response to the first material video being earlier than the second material video, the first video segment is a segment of video at the end of the first material video, and the second video segment is a segment of video at the beginning of the second material video. For example, in response to the first material video being earlier than the second material video, the first video segment may be a 5 second video segment at the end of the first material video, and the second video segment may be a 5 second video segment at the beginning of the second material video.

Optionally, in response to the first material video being later than the second material video, the first video segment is a segment of video at the beginning of the first material video, and the second video segment is a segment of video at the end of the second material video. For example, in response to the first material video being later than the second material video, the first video segment may be a 5 second video segment at the beginning of the first material video, and the second video segment may be a 5 second video segment at the end of the second material video.

Optionally, the first video segment and the second video segment may have an identical length. For example, in response to the first video segment being a 5 second video segment, the second video segment may be a 5 second video segment, and in response to the first video segment being a 10 second video segment, the second video segment may be a 10 second video segment. Optionally, the first video segment and the second video segment may have different lengths. For example, in response to the first video segment being a 5 second video segment, the second video segment may be a 3 second video segment, and in response to the first video segment being a 5 second video segment, the second video segment may be a 10 second video segment.

Optionally, the length of the first video segment may be determined according to the length of the first material video and a first preset ratio. For example, in response to the first material video being a 20 second video and the first preset ratio being 0.1, the first video segment is a 2 second video. In response to the first material video being a 30 second video and the first preset ratio being 0.5, the first video segment is a 15 second video.

Optionally, the length of the first video segment may be determined according to the length of the second material video and a second preset ratio. For example, in response to the second material video being a 10 second video and the first preset ratio being 0.3, the first video segment is a 3 second video. In response to the first material video being a 5 second video and the first preset ratio being 0.2, the first video segment is a 1 second video.

Optionally, the length of the first video segment and the length of the second video segment may each also be a preset length. For example, both the first video segment and the second video segment may each be a 5 second video segment. In response to the first material video and the second material video being less than 5 second, the length of the first video segment and the length of the second video segment are determined using other methods. The length of the first video segment and the length of the second video segment may also be determined by other methods in the embodiments of the present disclosure, which will not be limited in the embodiments of the present disclosure.

According to the method described above, the image features and the audio features corresponding to every adjacent material videos may be obtained.

The process of determining the first video segment and the second video segment is described below with reference to FIG. 4.

FIG. 4 is a schematic diagram of a first video segment and a second video segment provided by the embodiments of the present disclosure. Referring to FIG. 4, a first video is included. The first video includes material video A and material video B. The material video A is earlier than the material video B. A segment of video of a preset duration is clipped from the end of the material video A, and this segment of video is determined as the first video segment. A segment of video of a preset duration is clipped from the beginning of the material video B, and this segment of video is determined as the second video segment. Because the positions of the first video segment and the second video segment are close, the first video segment and the second video segment can accurately reflect a content feature between the material videos, thus improving the accuracy of determining the video transition effect and enhancing the video synthesis effect.

S203: acquiring a plurality of transition effect features corresponding to a plurality of video transition effects.

Optionally, a video transition effect refers to an effect added between different shots and in switching shots. For example, in video editing, a plurality of material videos are captured by different capturing apparatuses (or different contents captured by the same capturing apparatus). In order to avoid low fluency of joining when merging the plurality of material videos, the video transition effects may be added between different material videos to enhance the video merging effect. For example, the video transition effect may include an effect such as wipe, lap dissolve, and page turn, and the video transition effect may also be any other effect, which will not be limited in the embodiments of the present disclosure.

The video transition effect is described below with reference to FIG. 5.

FIG. 5 is a schematic diagram of a video transition effect provided by the embodiments of the present disclosure. Referring to FIG. 5, a first video is included. The first video plays a first material video, and the content of the first material video is letter A. When the playing of the first material video is finished, the first material video slides leftwards and the second material video slides rightwards, in which the content of the second material video is letter B. When the video transition effect (a sliding effect) is finished, the first video plays the second material video. In this way, the first material video and the second material video are joined by the sliding effect, thereby making the playing of the video smoother and improving the playing effect of the video.

Optionally, a transition effect feature is used to indicate a feature of the video transition effect. For example, the transition effect feature may be a feature vector. Different video transition effects correspond to different feature vectors.

Optionally, the plurality of transition effect features corresponding to the plurality of video transition effects may be acquired according to the following feasible implementation: acquiring an effect classification model corresponding to the plurality of video transition effects. Optionally, the effect classification model is configured to classify the plurality of video transition effects. For example, the effect classification model is capable of classifying 10 video transition effects. The effect classification model may also be capable of classifying 20 video transition effects. It should be noted that after the effect classification model has been trained, the types of the classified video transition effects are also determined. If a new video transition effect needs to be added, the effect classification model needs to be retrained.

Feature vectors corresponding to the video transition effects are acquired by the effect classification model and the vectors are determined as the transition effect features. For example, after the effect classification model has been trained, internal parameters of the effect classification model include the feature vector corresponding to each video transition effect, and the feature vector may be determined as the transition effect feature. For example, after the effect classification model has been trained, unit vectors in the middles of all the video transition effects are extracted as features from the same data set, and the feature vectors corresponding to the video transition effects are averaged, thereby obtaining the unique one transition effect feature of each video transition effect. For example, in response to the effect classification model being capable of classifying 30 video transition effects, the electronic device is capable of obtaining 30 feature vectors corresponding to 30 video transition effects by the effect classification model.

Optionally, when the effect classification model is being trained, a sufficient quantity of training data needs to be acquired. Therefore, the transition effects may be removed from the video that has been clipped (a video transition type has been added to the video), and the remaining video may be used as the training data (in which a label of the transition effect may be acquired by parsing a clipping template or provided manually, which will not be limited in the embodiments of the present disclosure) to train the effect classification model. Optionally, because the video from which the transition effects have been deleted has a small decrease in length, the video before the deletion of the transition effects may also be used as the training data. Thus, the workload of acquiring training samples is reduced and the model training efficiency is improved.

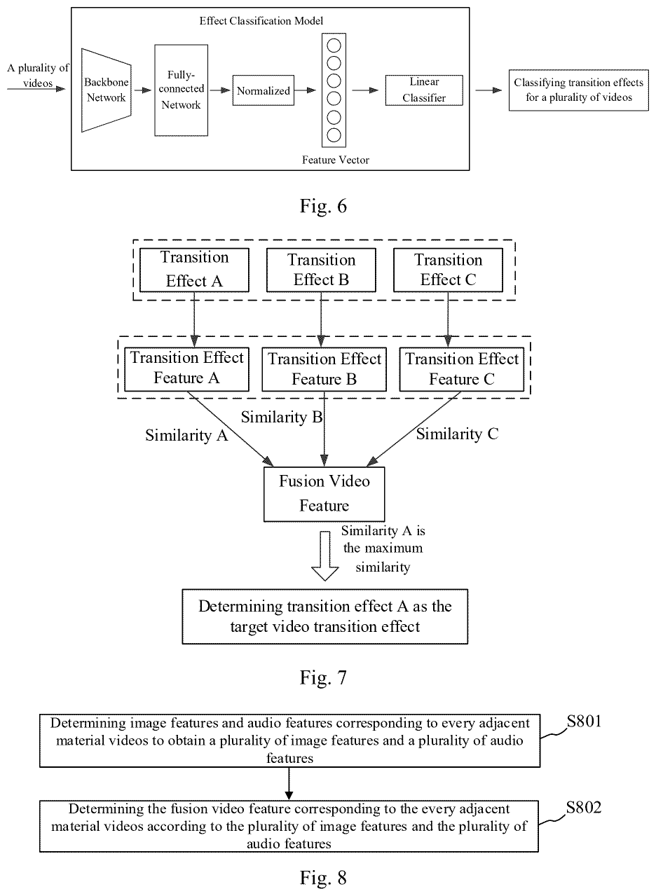

A process of determining the transition effect features is described below with reference to FIG. 6.

FIG. 6 is a schematic diagram of a transition effect feature provided by the embodiments of the present disclosure. Referring to FIG. 6, an effect classification model is included. A plurality of videos are input to the effect classification model, and each video includes a transition effect. The plurality of videos are processed by a backbone network so that the feature of each video can be obtained. Optionally, the backbone network may be replaced with other network results that can extract video features, which will not be limited in the embodiments of the present disclosure.

Referring to FIG. 6, the features of the videos are fused by a fully-connected network, and the fusion feature is normalized and converted to a unit vector. The unit vector is processed by a linear classifier, and then a plurality of transition effects are classified. After the effect classification model has been trained, the feature vectors therein are used as the transition effect features of the associated video transition effects.

S204: determining a target video transition effect between the every adjacent material videos from the plurality of video transition effects according to the fusion video feature and the plurality of transition effect features.

Optionally, the electronic device may determine the target video transition effect between the every adjacent material videos according to the following feasible implementation: acquiring a first similarity between the fusion video feature and each transition effect feature to obtain a plurality of first similarities. For example, for the fusion video feature corresponding to any adjacent material videos, a cosine similarity or a Euclidean distance between the fusion video feature and each transition effect feature may be acquired, and the cosine similarity or the Euclidean distance may be determined as the first similarity. For example, the electronic device acquires transition effect feature A of video transition effect A and transition effect feature B of video transition effect B. The electronic device may determine a cosine similarity between the fusion video feature and the transition effect feature A and a cosine similarity between the fusion video feature and the transition effect feature B.

Optionally, the electronic device may acquire the maximum first similarity from a plurality of first similarities, and determine the video transition effect corresponding to the maximum first similarity as the target video transition effect between the adjacent material videos corresponding to the fusion video feature. For example, in response to the similarity between the fusion video feature and the transition effect feature A being 70% and the similarity between the fusion video feature and the transition effect feature B being 90%, the transition effect feature B is determined as the target video transition effect, and the transition effect between the adjacent material videos corresponding to the fusion video feature is determined as the transition effect B.

A process of determining the target video transition effect is described below with reference to FIG. 7.

FIG. 7 is a schematic diagram of determining a target video transition effect provided by the embodiments of the present disclosure. Referring to FIG. 7, transition effect A, transition effect B, and transition effect C are included. The feature of the transition effect A is determined as transition effect feature A, the feature of transition effect B is determined as transition effect feature B, and the feature of transition effect C is determined as transition effect feature C. Similarity A between the transition effect feature A and the fusion video feature, similarity B between the transition effect feature B and the fusion video feature acquired, and similarity C between the transition effect feature C and the fusion video feature are acquired. Because the similarity A is the maximum similarity, the transition effect A corresponding to the transition effect feature A is determined as the target video transition effect corresponding to the fusion video feature.

S205: determining a second video according to the plurality of material videos and the target video transition effect.

Optionally, the target video transition effect may be provided between associated adjacent materials, and then the plurality of material videos are spliced to determine the second video. For example, the first video includes material video A, material video B, and material video C. The material video A and the material video B are adjacent videos, and the material video B and the material video C are adjacent videos. In response to the target video transition effect between the material video A and the material video B being wipe and the target video transition effect between the material video B and the material video C being page turn, when 3 material videos are being merged, the wipe effect is added between the material video A and the material video B, and the page turn effect is added between the material video B and the material video C, thereby obtaining the second video.

A video processing method provided by the embodiments of the present disclosure includes: acquiring the first video including a plurality of material videos, determining the fusion video feature corresponding to every adjacent material videos, acquiring the plurality of transition effect features corresponding to the plurality of video transition effects, acquiring the first similarity between the fusion video feature and each transition effect feature, acquiring the maximum first similarity from a plurality of first similarities, determining the video transition effect corresponding to the maximum first similarity as the target video transition effect between the adjacent material videos corresponding to the fusion video feature, and determining the second video according to the plurality of material videos and a plurality of target video transition effects. In the above-mentioned video processing method, because the fusion video feature can accurately indicate the video features of the adjacent material videos, and the video transition effect having the highest matching degree with the adjacent material videos can be accurately determined with the fusion video feature and the transition effect features, thereby enhancing the video synthesis effect.

On the basis of the embodiment shown in FIG. 2, a method of determining the fusion video feature corresponding to adjacent material videos in the above-mentioned video processing method is described with reference to FIG. 8.

FIG. 8 is a schematic flowchart of a method for determining a fusion video feature provided by the embodiments of the present disclosure. Referring to FIG. 8, the method includes the following steps.

S801: determining image features and audio features corresponding to every adjacent material videos to obtain a plurality of image features and a plurality of audio features.

Optionally, for any adjacent first material video and second material video, the plurality of image features and the plurality of audio features may be obtained according to the following feasible implementation: acquiring a first video segment in the first material video and a second video segment in the second material video. It should be noted that the process of acquiring the first video segment and the second video segment may be referred to step S202, which will not be described redundantly in this embodiment of the present disclosure.

For example, the image features and audio features corresponding to the first material video and the second material video are determined according to the first video segment and the second video segment. Optionally, the electronic device may determine the image features and the audio features corresponding to the first material video and the second material video according to the following feasible implementation: acquiring a first image feature and a first audio feature corresponding to the first video segment. For example, the first video segment includes images (a video frame) and an audio. The images in the first video segment are processed by a feature extraction model (e.g., a backbone network, or a neutral network) to obtain the first image feature, and the audio in the first video segment is processed by the feature extraction model to obtain the first audio feature.

A second image feature and a second audio feature corresponding to the second video segment are acquired. For example, the second video segment also includes images and an audio. The images in the second video segment are processed by the feature extraction model to obtain the second image feature, and the audio in the second video segment is processed by the feature extraction model to obtain the second audio feature.

The first image feature and the second image feature are determined as the image features corresponding to the first material video and the second material video, and the first audio feature and the second audio feature are determined as the audio features corresponding to the first material video and the second material video. For example, the electronic device obtains image feature A and audio feature A from the first video segment and image feature B and audio feature B from the second video segment, and then determines the image feature A and the image feature B as the image features of the adjacent material videos and the audio feature A and the audio feature B as the audio features of the adjacent material videos. In this way, the image feature and the audio feature corresponding to every adjacent material videos can be acquired.

S802: determining the fusion video feature corresponding to the every adjacent material videos according to the plurality of image features and the plurality of audio features.

Optionally, the fusion video feature corresponding to the every adjacent material videos may be determined according to the following feasible implementation: acquiring a first position code of each image feature in the first video and a second position code of each audio feature in the first video. Optionally, the first position code is used to indicate a position of the image feature, and the second position code is used to indicate a position of the audio feature. For example, the electronic device may acquire associated position codes according to the material videos corresponding to the image features and the audio features.

The fusion video feature corresponding to the every adjacent material videos is determined according to the plurality of image features, the plurality of audio features, the first position codes, and the second position codes. Optionally, the plurality of image features, the plurality of audio features, the first position codes, and the second position codes may be processed by a first model that has been trained, to obtain the fusion feature corresponding to the every adjacent material videos. For example, the first model may be an encoder that can fuse context information and multi-modality features, and merge features belonging to the same video transition effect to obtain the fusion video feature corresponding to the every adjacent material videos.

According to the method for determining the fusion video feature provided by the embodiments of the present disclosure, the image features and the audio features corresponding to every adjacent material videos are determined to obtain the plurality of image features and the plurality of audio features, and the fusion video feature corresponding to the every adjacent material videos is determined according to the plurality of image features and the plurality of audio features. In this way, because the plurality of image features and the plurality of audio features can reflect the multi-modality features of the first video and the first position codes and the second position codes can reflect the context information of the first video, the accuracy of the fusion video feature is high, whereby the video synthesis effect can be enhanced.

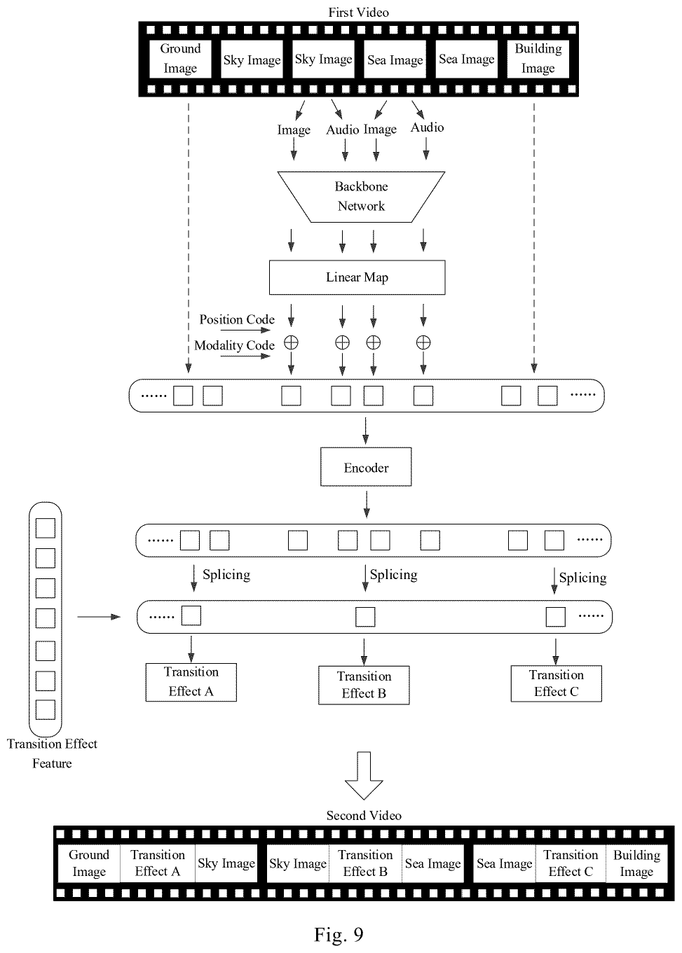

On the basis of any one of the above-mentioned embodiments, the process of the video processing method is described below with reference to FIG. 9.

FIG. 9 is a schematic diagram of a process of a video processing method provided by the embodiments of the present disclosure. Referring to FIG. 9, a first video is included. The first video includes a ground image, a sky image, a sea image, a building image, and the like. The first video is split into a plurality of material videos according to the video content of the first video. For adjacent material videos, a fusion video feature corresponding to the adjacent material videos is acquired. Taking the sky image and the sea image in FIG. 9 as an example (the sky image and the sea image are in different material videos, respectively), an image and an audio of a sky image video segment are acquired, and an image and an audio of a sea image video segment are acquired.

Referring to FIG. 9, 2 images and 2 audios are processed by a backbone network, and processing results are linearly mapped, and a position code and a modality code are added to an output result. Thus, 2 image features corresponding to 2 images and 2 audio features corresponding to 2 audios are obtained. It should be noted that in the embodiment shown in FIG. 9, a plurality of image features and video features may be obtained for other adjacent material videos by the method described above.

Referring to FIG. 9, the plurality of image features and the plurality of audio features are processed by an encoder to obtain a plurality of features by fusing context information. 2 image features and 2 audio features corresponding to the adjacent material videos are spliced to obtain a fusion video feature corresponding to adjacent material videos. Transition effect features are acquired, and a similarity between each fusion video feature and each transition effect feature is determined.

Referring to FIG. 9, transition effect A, transition effect B, and transition effect C are determined as target video transition effects (other transition effects are not shown in the figure) according to the similarity between the fusion video feature and each transition effect feature. The transition effect A is added between the ground image and the sky image, the transition effect B is added between the sky image and the sea image, and the transition effect C is added between the sea image and the building image, thereby obtaining a second video. It should be noted that the above-mentioned process may be implemented by a model. In order to optimize the similarity between the fusion video feature extracted from materials and a video transition effect, a triplet loss may be used as a loss function to update the parameters of the model.

According to the method described above, the electronic device can automatically add the transition effects between the material videos of the first video, and because the fusion video feature is obtained by fusing the image features and the audio features of the adjacent material videos, a cross-modality search function is achieved, and then the video transition effect having the highest matching degree with the adjacent material video contents can be accurately determined with the fusion video feature and the maintained transition effect features. Thus, the video synthesis effect can be improved.

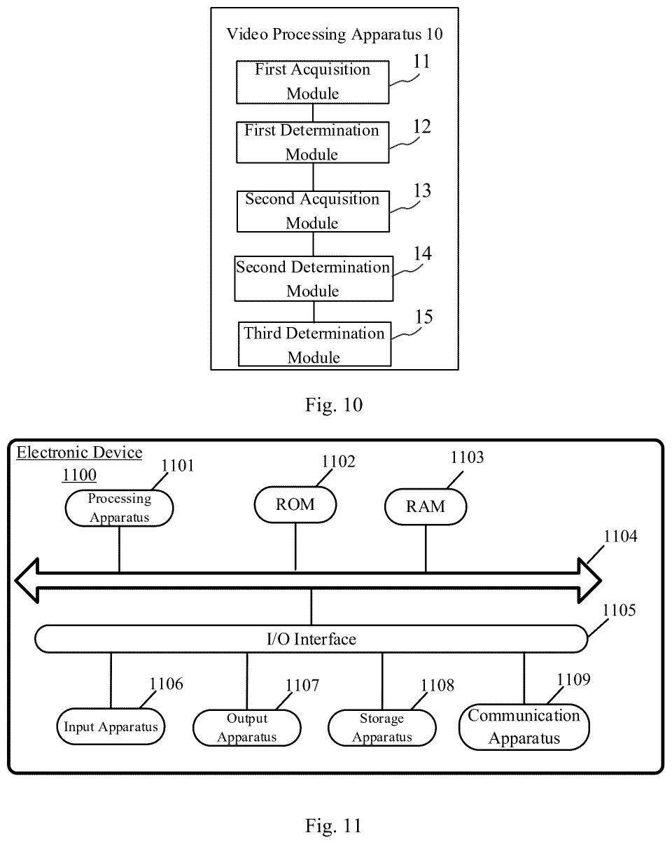

FIG. 10 is a schematic structural diagram of a video processing apparatus provided by the embodiments of the present disclosure. Referring to FIG. 10, the video processing apparatus 10 includes a first acquisition module 11, a first determination module 12, a second acquisition module 13, a second determination module 14, and a third determination module 15.

The first acquisition module 11 is configured to acquire a first video, and the first video includes a plurality of material videos.

The first determination module 12 is configured to determine a fusion video feature corresponding to every adjacent material videos, and the fusion video feature is used to indicate image features and audio features of adjacent material videos.

The second acquisition module 13 is configured to acquire a plurality of transition effect features corresponding to a plurality of video transition effects.

The second determination module 14 is configured to determine a target video transition effect between the every adjacent material videos from the plurality of video transition effects according to the fusion video feature and the plurality of transition effect features.

The third determination module 15 is configured to determine a second video according to the plurality of material videos and the target video transition effect.

In an optional embodiment, the first determination module 12 is configured to:
determine image features and audio features corresponding to the every adjacent material videos to obtain a plurality of image features and a plurality of audio features; and
determine the fusion video feature corresponding to the every adjacent material videos according to the plurality of image features and the plurality of audio features.

In an optional embodiment, the first determination module 12 is configured to:
acquire a first video segment in the first material video and a second video segment in the second material video; and
determine the image features and the audio features corresponding to the first material video and the second material video according to the first video segment and the second video segment.

In an optional embodiment, the first determination module 12 is configured to:
acquire a first image feature and a first audio feature corresponding to the first video segment;
acquire a second image feature and a second audio feature corresponding to the second video segment; and
determine the first image feature and the second image feature as the image features corresponding to the first material video and the second material video, and determine the first audio feature and the second audio feature as the audio features corresponding to the first material video and the second material video.

In an optional embodiment, the first determination module 12 is configured to:
acquire a first position code of each image feature in the first video and a second position code of each audio feature in the first video; and
determine the fusion video feature corresponding to the every adjacent material videos according to the plurality of image features, the plurality of audio features, the first position code, and the second position code.

In an optional embodiment, the first material video is earlier than the second material video, the first video segment is a video segment at the end of the first material video, and the second video segment is a video segment at the beginning of the second material video.

In an optional embodiment, the second determination module 14 is configured to:
acquire a first similarity between the fusion video feature and each transition effect feature to obtain a plurality of first similarities;
acquire the maximum first similarity from the plurality of first similarities; and
determine a video transition effect corresponding to the maximum first similarity as the target video transition effect between the adjacent material videos corresponding to the fusion video feature.

In an optional embodiment, the second acquisition module 13 is configured to:
acquire an effect classification model corresponding to the plurality of video transition effects, in which the effect classification model is configured to classify the plurality of video transition effects; and
acquire feature vectors corresponding to the video transition effects by the effect classification model and determine the feature vectors as the transition effect features.

The video processing apparatus provided in this embodiment can be used to execute the technical solution of the above-mentioned method embodiment. Its implementation principle and technical effect are similar, and this embodiment will not be repeated here.

FIG. 11 is a schematic structural diagram of an electronic device provided by the embodiments of the present disclosure. Referring to FIG. 11, FIG. 11 illustrates a schematic structural diagram of an electronic device 1100 suitable for implementing the embodiments of the present disclosure. The electronic device 1100 may be a terminal device of a server. The terminal device may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and a fixed terminal such as a digital TV, a desktop computer, or the like. The electronic device illustrated in FIG. 11 is merely an example, and should not pose any limitation to the functions and the range of use of the embodiments of the present disclosure.

As illustrated in FIG. 11, the electronic device 1100 may include a processing apparatus 1101 (e.g., a central processing unit, a graphics processing unit, etc.), which can perform various suitable actions and processing according to a program stored in a read-only memory (ROM) 1102 or a program loaded from a storage apparatus 1108 into a random-access memory (RAM) 1103. The RAM 1103 further stores various programs and data required for operations of the electronic device 1100. The processing apparatus 1101, the ROM 1102, and the RAM 1103 are interconnected through a bus 1104. An input/output (I/O) interface 1105 is also connected to the bus 1104.

Usually, the following apparatuses may be connected to the I/O interface 1105: an input apparatus 1106 including, for example, a touch screen, a touch pad, a keyboard, a mouse, a camera, a microphone, an accelerometer, a gyroscope, or the like; an output apparatus 1107 including, for example, a liquid crystal display (LCD), a loudspeaker, a vibrator, or the like; a storage apparatus 1108 including, for example, a magnetic tape, a hard disk, or the like; and a communication apparatus 1109. The communication apparatus 1109 may allow the electronic device 1100 to be in wireless or wired communication with other devices to exchange data. While FIG. 11 illustrates the electronic device 1100 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 1109 and installed, or may be installed from the storage apparatus 1108, or may be installed from the ROM 1102. When the computer program is executed by the processing apparatus 1101, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the methods illustrated by the above-mentioned embodiments.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as a “unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, one or more embodiments of the present disclosure provide a video processing method, which includes:
acquiring a first video, in which the first video includes a plurality of material videos;
determining a fusion video feature corresponding to every adjacent material videos, in which the fusion video feature is used to indicate image features and audio features of adjacent material videos;
acquiring a plurality of transition effect features corresponding to a plurality of video transition effects;
determining a target video transition effect between the every adjacent material videos from the plurality of video transition effects according to the fusion video feature and the plurality of transition effect features; and
determining a second video according to the plurality of material videos and the target video transition effect.

According to one or more embodiments of the present disclosure, the determining the fusion video feature corresponding to the every adjacent material videos includes:
determining image features and audio features corresponding to the every adjacent material videos to obtain a plurality of image features and a plurality of audio features; and
determining the fusion video feature corresponding to the every adjacent material videos according to the plurality of image features and the plurality of audio features.

According to one or more embodiments of the present disclosure, for any adjacent first material video and second material video, determining image features and audio features corresponding to the first material video and the second material video includes:
acquiring a first video segment in the first material video and a second video segment in the second material video; and
determining the image features and the audio features corresponding to the first material video and the second material video according to the first video segment and the second video segment.

According to one or more embodiments of the present disclosure, the determining the image features and the audio features corresponding to the first material video and the second material video according to the first video segment and the second video segment, includes:
acquiring a first image feature and a first audio feature corresponding to the first video segment;
acquiring a second image feature and a second audio feature corresponding to the second video segment; and
determining the first image feature and the second image feature as the image features corresponding to the first material video and the second material video, and determining the first audio feature and the second audio feature as the audio features corresponding to the first material video and the second material video.

According to one or more embodiments of the present disclosure, the determining the fusion video feature corresponding to the every adjacent material videos according to the plurality of image features and the plurality of audio features, includes:
acquiring a first position code of each image feature in the first video and a second position code of each audio feature in the first video; and
determining the fusion video feature corresponding to the every adjacent material videos according to the plurality of image features, the plurality of audio features, the first position code, and the second position code.

According to one or more embodiments of the present disclosure, the first material video is earlier than the second material video, the first video segment is a video segment at the end of the first material video, and the second video segment is a video segment at the beginning of the second material video.

According to one or more embodiments of the present disclosure, the determining the target video transition effect between the every adjacent material videos from the plurality of video transition effects according to the fusion video feature and the plurality of transition effect features, includes:
acquiring a first similarity between the fusion video feature and each transition effect feature to obtain a plurality of first similarities;
acquiring a maximum first similarity from the plurality of first similarities; and
determining a video transition effect corresponding to the maximum first similarity as the target video transition effect between the adjacent material videos corresponding to the fusion video feature.

According to one or more embodiments of the present disclosure, the acquiring the plurality of transition effect features corresponding to the plurality of video transition effects includes:
acquiring an effect classification model corresponding to the plurality of video transition effects, in which the effect classification model is configured to classify the plurality of video transition effects; and
acquiring feature vectors corresponding to the video transition effects by the effect classification model and determining the feature vectors as the transition effect features.

In a second aspect, one or more embodiments of the present disclosure provide a video processing apparatus, which includes a first acquisition module, a first determination module, a second acquisition module, a second determination module, and a third determination module.

The first acquisition module is configured to acquire a first video, and the first video comprises a plurality of material videos.

The first determination module is configured to determine a fusion video feature corresponding to every adjacent material videos, and the fusion video feature is used to indicate image features and audio features of adjacent material videos.

The second acquisition module is configured to acquire a plurality of transition effect features corresponding to a plurality of video transition effects.

The second determination module is configured to determine a target video transition effect between the every adjacent material videos from the plurality of video transition effects according to the fusion video feature and the plurality of transition effect features.

The third determination module is configured to determine a second video according to the plurality of material videos and the target video transition effect.

In an optional embodiment, the first determination module is configured to:
determine image features and audio features corresponding to the every adjacent material videos to obtain a plurality of image features and a plurality of audio features; and
determine the fusion video feature corresponding to the every adjacent material videos according to the plurality of image features and the plurality of audio features.

In an optional embodiment, the first determination module is configured to:
acquire a first video segment in the first material video and a second video segment in the second material video; and
determine the image features and the audio features corresponding to the first material video and the second material video according to the first video segment and the second video segment.

In an optional embodiment, the first determination module is configured to:
acquire a first image feature and a first audio feature corresponding to the first video segment;
acquire a second image feature and a second audio feature corresponding to the second video segment; and
determine the first image feature and the second image feature as the image features corresponding to the first material video and the second material video, and determine the first audio feature and the second audio feature as the audio features corresponding to the first material video and the second material video.

In an optional embodiment, the first determination module is configured to:
acquire a first position code of each image feature in the first video and a second position code of each audio feature in the first video; and
determine the fusion video feature corresponding to the every adjacent material videos according to the plurality of image features, the plurality of audio features, the first position code, and the second position code.

In an optional embodiment, the first material video is earlier than the second material video, the first video segment is a video segment at the end of the first material video, and the second video segment is a video segment at the beginning of the second material video.

In an optional embodiment, the second determination module is configured to:
acquire a first similarity between the fusion video feature and each transition effect feature to obtain a plurality of first similarities;
acquire the maximum first similarity from the plurality of first similarities; and
determine a video transition effect corresponding to the maximum first similarity as the target video transition effect between the adjacent material videos corresponding to the fusion video feature.

In an optional embodiment, the second acquisition module is configured to:
acquire an effect classification model corresponding to the plurality of video transition effects, in which the effect classification model is configured to classify the plurality of video transition effects; and
acquire feature vectors corresponding to the video transition effects by the effect classification model and determine the feature vectors as the transition effect features.

In a third aspect, the embodiments of the present disclosure provide an electronic device, which includes a processor and a memory;
the memory is configured to store computer-executable instructions; and
the processor is configured to execute the computer-executable instructions stored in the memory, to perform the video processing method according to the first aspect or any embodiment in the first aspect.

In a fourth aspect, the embodiments of the present disclosure provide a computer-readable storage medium, which stores computer-executable instructions, and a processor, when executing the computer-executable instructions, implements the video processing method according to the first aspect or any embodiment in the first aspect.

In a fifth aspect, the embodiments of the present disclosure provide a computer program product, which includes a computer program, and the computer program, when executed by a processor, implements the video processing method according to the first aspect or any embodiment in the first aspect.

In a sixth aspect, the embodiments of the present disclosure provide a computer program, and the computer program, when executed by a processor, implements the video processing method according to the first aspect or any embodiment in the first aspect.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A video processing method, comprising:
acquiring a first video, wherein the first video comprises a plurality of material videos;
determining a fusion video feature corresponding to adjacent material videos, wherein the fusion video feature is used to indicate image features and audio features of adjacent material videos;
acquiring a plurality of transition effect features corresponding to a plurality of video transition effects;
determining a target video transition effect between the adjacent material videos from the plurality of video transition effects according to the fusion video feature and the plurality of transition effect features; and
determining a second video according to the plurality of material videos and the target video transition effect.

2. The method according to claim 1, wherein the determining the fusion video feature corresponding to the adjacent material videos comprises:
determining image features and audio features corresponding to the adjacent material videos to obtain a plurality of image features and a plurality of audio features; and
determining the fusion video feature corresponding to the adjacent material videos according to the plurality of image features and the plurality of audio features.

3. The method according to claim 2, wherein for any adjacent first material video and second material video, determining image features and audio features corresponding to the first material video and the second material video comprises:
acquiring a first video segment in the first material video and a second video segment in the second material video; and
determining the image features and the audio features corresponding to the first material video and the second material video according to the first video segment and the second video segment.

4. The method according to claim 3, wherein the determining the image features and the audio features corresponding to the first material video and the second material video according to the first video segment and the second video segment, comprises:
acquiring a first image feature and a first audio feature corresponding to the first video segment;
acquiring a second image feature and a second audio feature corresponding to the second video segment; and
determining the first image feature and the second image feature as the image features corresponding to the first material video and the second material video, and determining the first audio feature and the second audio feature as the audio features corresponding to the first material video and the second material video.

5. The method according to claim 2, wherein the determining the fusion video feature corresponding to the adjacent material videos according to the plurality of image features and the plurality of audio features, comprises:
acquiring a first position code of each image feature in the first video and a second position code of each audio feature in the first video; and
determining the fusion video feature corresponding to the adjacent material videos according to the plurality of image features, the plurality of audio features, the first position code, and the second position code.

6. The method according to claim 3, wherein the first material video is earlier than the second material video, the first video segment is a video segment at the end of the first material video, and the second video segment is a video segment at the beginning of the second material video.

7. The method according to claim 1, wherein the determining the target video transition effect between the adjacent material videos from the plurality of video transition effects according to the fusion video feature and the plurality of transition effect features, comprises:
acquiring a first similarity between the fusion video feature and each transition effect feature to obtain a plurality of first similarities;
acquiring a maximum first similarity from the plurality of first similarities; and
determining a video transition effect corresponding to the maximum first similarity as the target video transition effect between the adjacent material videos corresponding to the fusion video feature.

8. The method according to claim 1, wherein the acquiring the plurality of transition effect features corresponding to the plurality of video transition effects comprises:
acquiring an effect classification model corresponding to the plurality of video transition effects, wherein the effect classification model is configured to classify the plurality of video transition effects; and
acquiring feature vectors corresponding to the video transition effects by the effect classification model and determining the feature vectors as the transition effect features.

9. (canceled)

10. An electronic device, comprising a processor and a memory,
wherein the memory is configured to store computer-executable instructions; and
the processor is configured to execute the computer-executable instructions stored in the memory, to perform a video processing method, which comprises:
acquiring a first video, wherein the first video comprises a plurality of material videos;
determining a fusion video feature corresponding to adjacent material videos, wherein the fusion video feature is used to indicate image features and audio features of adjacent material videos;
acquiring a plurality of transition effect features corresponding to a plurality of video transition effects;
determining a target video transition effect between the adjacent material videos from the plurality of video transition effects according to the fusion video feature and the plurality of transition effect features; and
determining a second video according to the plurality of material videos and the target video transition effect.

11. A non-transitory computer-readable storage medium, storing computer-executable instructions, wherein a processor, when executing the computer-executable instructions, implements a video processing method, which comprises:
acquiring a first video, wherein the first video comprises a plurality of material videos;
determining a fusion video feature corresponding to adjacent material videos, wherein the fusion video feature is used to indicate image features and audio features of adjacent material videos;
acquiring a plurality of transition effect features corresponding to a plurality of video transition effects;
determining a target video transition effect between the adjacent material videos from the plurality of video transition effects according to the fusion video feature and the plurality of transition effect features; and
determining a second video according to the plurality of material videos and the target video transition effect.

12. (canceled)

13. (canceled)

14. The method according to claim 3, wherein the determining the fusion video feature corresponding to the adjacent material videos according to the plurality of image features and the plurality of audio features, comprises:
acquiring a first position code of each image feature in the first video and a second position code of each audio feature in the first video; and
determining the fusion video feature corresponding to the adjacent material videos according to the plurality of image features, the plurality of audio features, the first position code, and the second position code.

15. The method according to claim 4, wherein the determining the fusion video feature corresponding to the adjacent material videos according to the plurality of image features and the plurality of audio features, comprises:
acquiring a first position code of each image feature in the first video and a second position code of each audio feature in the first video; and
determining the fusion video feature corresponding to the adjacent material videos according to the plurality of image features, the plurality of audio features, the first position code, and the second position code.

16. The method according to claim 4, wherein the first material video is earlier than the second material video, the first video segment is a video segment at the end of the first material video, and the second video segment is a video segment at the beginning of the second material video.

17. The method according to claim 2, wherein the determining the target video transition effect between the adjacent material videos from the plurality of video transition effects according to the fusion video feature and the plurality of transition effect features, comprises:
acquiring a first similarity between the fusion video feature and each transition effect feature to obtain a plurality of first similarities;
acquiring a maximum first similarity from the plurality of first similarities; and
determining a video transition effect corresponding to the maximum first similarity as the target video transition effect between the adjacent material videos corresponding to the fusion video feature.

18. The method according to claim 3, wherein the determining the target video transition effect between the adjacent material videos from the plurality of video transition effects according to the fusion video feature and the plurality of transition effect features, comprises:
acquiring a first similarity between the fusion video feature and each transition effect feature to obtain a plurality of first similarities;
acquiring a maximum first similarity from the plurality of first similarities; and
determining a video transition effect corresponding to the maximum first similarity as the target video transition effect between the adjacent material videos corresponding to the fusion video feature.

19. The method according to claim 4, wherein the determining the target video transition effect between the adjacent material videos from the plurality of video transition effects according to the fusion video feature and the plurality of transition effect features, comprises:
acquiring a first similarity between the fusion video feature and each transition effect feature to obtain a plurality of first similarities;
acquiring a maximum first similarity from the plurality of first similarities; and
determining a video transition effect corresponding to the maximum first similarity as the target video transition effect between the adjacent material videos corresponding to the fusion video feature.

20. The method according to claim 5, wherein the determining the target video transition effect between the adjacent material videos from the plurality of video transition effects according to the fusion video feature and the plurality of transition effect features, comprises:
acquiring a first similarity between the fusion video feature and each transition effect feature to obtain a plurality of first similarities;
acquiring a maximum first similarity from the plurality of first similarities; and
determining a video transition effect corresponding to the maximum first similarity as the target video transition effect between the adjacent material videos corresponding to the fusion video feature.

21. The method according to claim 6, wherein the determining the target video transition effect between the adjacent material videos from the plurality of video transition effects according to the fusion video feature and the plurality of transition effect features, comprises:
acquiring a first similarity between the fusion video feature and each transition effect feature to obtain a plurality of first similarities;
acquiring a maximum first similarity from the plurality of first similarities; and
determining a video transition effect corresponding to the maximum first similarity as the target video transition effect between the adjacent material videos corresponding to the fusion video feature.

22. The method according to claim 2, wherein the acquiring the plurality of transition effect features corresponding to the plurality of video transition effects comprises:
acquiring an effect classification model corresponding to the plurality of video transition effects, wherein the effect classification model is configured to classify the plurality of video transition effects; and
acquiring feature vectors corresponding to the video transition effects by the effect classification model and determining the feature vectors as the transition effect features.

23. The method according to claim 3, wherein the acquiring the plurality of transition effect features corresponding to the plurality of video transition effects comprises:
acquiring an effect classification model corresponding to the plurality of video transition effects, wherein the effect classification model is configured to classify the plurality of video transition effects; and
acquiring feature vectors corresponding to the video transition effects by the effect classification model and determining the feature vectors as the transition effect features.
